(19) United States
(12) Patent Application Publication
(10) Pub. No.: US 2008/0196674 A1
(43) Pub. Date: Aug. 21, 2008

(54) Foot bath kit

(75) Inventors: Robert L. Buck, Holmen, WI (US); Kevin L. Torgerson, Holmen, WI (US)

Correspondence Address: SMITH LAW OFFICE, 440 SCIENCE DR., SUITE 302, MADISON, WI, 53711, US

(73) Assignee: WestfaliaSurge, Inc., Naperville, IL (US)

(21) Appl. No.: 12/012,798

(22) Filed: Feb. 5, 2008

Related U.S. Application Data
(63) Continuation-in-part of application No. 11/300,616, filed on Dec. 14, 2005.
(60) Provisional application No. 60/723,462, filed on Oct. 4, 2005.

(30) Foreign Application Priority Data
Oct. 3, 2006 (US) PCT/US06/38729
Dec. 14, 2006 (US) PCT/US06/47806

(51) Int. Cl. A01K 29/00

(52) U.S. Cl. 119/673

(57) ABSTRACT

The present invention is directed to a kit for a bovine foot treatment bath for being attached to a foot bath. The kit includes: a chemical and water inlet and/or a downstream drain assembly for being attached to a foot bath.

This is a continuation-in-part application that claims priority on Provisional Application No. 60/723,462 filed Oct. 4, 2005, U.S. application Ser. No. 11/300,616 filed Dec. 14, 2005, PCT Application No. PCT/US06/38729 filed Oct. 3, 2006, and PCT Application No. PCT/US06/47806 filed Dec. 14, 2006 the disclosures of which are incorporated by reference herein.

### FIELD AND BACKGROUND OF THE INVENTION

The present invention relates generally to foot bath systems for dairy animals, and more particularly to a foot bath kit having components for being installed in an existing foot bath made of concrete, for example.

Foot baths for animals have been known for some time. Various apparatus and methods for feeding water and chemicals to baths and then flushing water, chemicals, and debris from the bath have been developed. In prior foot bath systems, a foot bath made of metal or plastic had integrally formed nozzles or orifices through which water and treatment chemicals were added to the bath at desired intervals.

In addition, some baths used stationary walls or curbs at the downstream end to retain water and chemicals in the bath. When it became necessary to replenish the water and treatment chemicals, and to rinse the bath of debris and dirt; the bath was flushed with a high flow volume and/or pressure of water. The water flushed the bath by forcing spent cleaning and treatment liquids, and debris over the curb.

Various nozzle arrangements have been devised to flush baths efficiently. In addition, various outlets have been devised to replace the downstream wall or curb so that rinsing is more efficient and dependable.

Nonetheless, some installations having heavy animal traffic could experience damage and increased maintenance and repair costs due to damage caused by animals stepping on various components of the foot bath system.

The present invention also relates generally to bovine hoof treatments, and more specifically to bovine hoof treatment compositions and methods having two or more separate components mixed at the dairy to improve efficacy and safety to humans and animals.

Lameness is one of the major problems facing the dairy industry in the world today. The cost of lameness is measured by lost milk production, culled cows, dead cows, additional labor, vet bills, and medicines for treatment. In the U.S. alone, the cost of lameness has been reported to be between $300 and $412 per cow. With an overall estimated incidence rate of 10% to 15%, the annual overall cost of lameness would exceed 570 million dollars. It is especially a problem in large herds, which are the fastest growing segment of the market. The prevalence of lameness in large herds is 50% or more and is reflected by an annual incidence of 60% to 70%. Infectious diseases of the foot or hoof are one of the primary causes of lameness.

Studies have showed that fully a third of all lameness in cows is caused by one disease, digital dermatitis. Digital dermatitis is present worldwide and is estimated to be present in 41% of herds smaller than 100 cows and from 64% to 82% in larger herds. Contagious and debilitating diseases of the bovine foot and hoof include such conditions as bovine hoof rot, digital dermatitis and interdigital dermatitis.

Hoof baths containing germicidal/cleaning chemicals and antibiotics and/or other biologics have been used on dairy operations in the attempt to prevent, control and treat these diseases. Hoof baths are generally located in the return alley of dairy milking barns or parlors. After being milked, the animal will typically walk through the hoof bath on the way back to where they are housed. The feet and hooves will many times contain accumulated dirt and manure, even after milking when at times the feet and hooves are sprayed with water or diluted chemicals. This is especially true in modern dairy facilities with housing contained in limited areas such as free stall or tie stall barns or dry lots instead of open pasture.

In addition, on passing through the hoof bath, the cows may defecate into the hoof bath. The added organic material or load to the hoof bath compromises the antimicrobial products' ability to work in the disinfection and cleansing of the cow feet where the causative microorganisms are located. For economic reasons, the use of antibacterial chemical and biological products in doses high enough to compensate for the organic material present in the hoof bath and to penetrate through organic material and whatever tissue may conceal or otherwise harbor the bacterial pathogens, is usually cost prohibitive. Other chemical products that are less expensive to use at higher doses have the disadvantage in that they may be toxic to the animals, the people working in the dairy facilities or the environment.

Also, many times when one product is used successfully (as in the treatment of digital dermatitis lesions) and the dose or frequency of the dose lessened after successfully eliminating the lesions, the clinical manifestations of the disease will reappear after a short time. One option utilized by many dairy producers is to alternate or rotate more than one chemical or antibiotic product at different times in the same hoof bath. There is at least anecdotal evidence that alternating different chemicals is effective in helping to reduce the incidence and prevalence of infectious diseases of the foot. However, this practice still does not compensate for the above-mentioned problems of using a high enough dose to overcome organic load while still producing a hoof bath that is safe and of low toxicity.

Prior hoof baths were typically recessed into the exit alley and were filled by hand or remotely through a system of pumps, pipes and valves. Dairy operators monitored the baths to determine when fresh chemicals and water needed to be added to the bath. Fresh bath water and chemicals are needed as chemicals lose their efficacy and/or the bath becomes fouled with dirt, debris, and manure.

To clear or flush dirt, debris, and manure from the baths, high pressure and high velocity water was pumped into the bath. Early hoof baths had an upstream end into which flushing water was pumped and a downstream end through which the flushing liquid and flushed materials flowed.

The downstream ends in some hoof bath systems were simple curbs or walls over which the fluid and material is forced by water pressure and/or velocity. Such systems tend to waste water and require unnecessarily high pump pressure and flow. In addition, the inherent nature of a fixed curb can prevent all of the debris from being flushed from the bath.

Drains in the downstream end were added to some such systems to improve flushing performance. Some drains were manually operated, while others were automated to synchronize with flushing and re-filling operations.

In an attempt to further improve flushing performance, at least one system attempted to create specific current flows in the bath during flushing operations by using nozzles of varying jet velocities, sizes, and arrangements. See Vander Veen, U.S. Pat. No. 6,739,286. Such precision is difficult to maintain in actual dairy environments that are subject to harsh conditions, extreme temperature changes, and damage from animals.

As stated above, some hoof bath systems mix chemical and water in the bath. See Vander Veen, U.S. Pat. No. 6,739,286, for example. Such systems can be effective when a single hoof bath is used in a dairy, but using separate chemical and water dispensers in more than one hoof bath unnecessarily complicates piping, pumps, and valves. Duplicate dispensing systems also add expense in building and monitoring such systems. Malfunctions in such duplicative and complicated systems are inevitable.

Accordingly, there is a need for another way to bring safe, efficacious and cost effective doses of these products to the site of the microbial pathogens on the animal without being unduly hindered by organic material that may be present in the bath or on the foot. In addition, there is a need for a system-wide approach for operating hoof baths that reduces initial capital and maintenance expense.

### SUMMARY OF THE INVENTION

A foot bath kit in accordance with the present invention enables the use of robust bath construction materials, such as concrete, while realizing the benefits of superior water and treatment chemical feed systems, as well as, efficient and dependable bath flushing. Bath structures can be constructed of concrete in advance with a kit having feed nozzles and/or efficient flushing systems being installed afterward. Repairing and replacing components of the kit are relatively simple and inexpensive because an entire bath system need not be taken out of service. Rather, only the affected component needs to be replaced and such replacement can be done in a short time without taking the bath out of service for extended periods.

A foot bath kit in accordance with the present invention can include an inlet and/or an outlet bladder assembly that can be installed in a foot bath to define upstream and downstream boundaries, respectfully. The kit is preferably installed in a concrete foot bath without a downstream end wall. The inlet and bladder assembly can serve as end walls and provide the necessary mechanical functions of delivering liquids (inlet) and opening and closing a downstream end for flushing the bath.

The inlet can be a manifold with multiple nozzles, and each nozzle can have mounted thereon a one-way valve to prevent clogging. Even if no inlet is installed as part of the kit, a downstream drain assembly can be used. The drain assembly can include a pneumatic bladder that allows drainage when it is uninflated, but prevents drainage when inflated.

A hoof bath system for dairy animals, the system comprising: an in situ chemical mixer; a water supply; a chemical and water mixer for receiving chemicals from the in situ chemical mixer and the water supply; a chemical and water distributor for distributing chemicals and water from the chemical and water mixer; a plurality of hoof baths for selectively receiving a mixture of chemicals and water from the chemical and water distributor; a bath flusher for receiving water from the water supply, the bath flusher for forcing water through the bath; and a system controller for synchronizing the chemical and water distributor and the bath flusher to flush the plurality of baths and refill the baths with a chemical and water mix.

The present invention also is directed to compositions and methods for combining or mixing compositions having two or more specific and complimentary antimicrobial components in a hoof bath just prior to use. Certain germicides when combined, act synergistically in such a way as to increase the efficacy of one or both of the germicides, as is the case with hydrogen peroxide and such germicidal inorganic salts as copper. In order for to gain maximum antimicrobial efficacy, the combined germicides must be used as soon as possible after combining before one or both of the germicides are used up due to oxidation or other type reactions with the other component. These components include one or more of certain antimicrobial salts of certain heavy metals including copper sulfate, copper acetate, copper formate, copper bromate, copper trichloroacetate, zinc sulfate, zinc acetate, zinc formate, zinc bromate or iron sulfate, iron acetate, iron formate, iron bromate or other heavy metal salts not listed. These components can also include such aldehydes as formaldehyde, gluteraldehyde and glycoxyaldehyde.

A second group of antimicrobial components should be mixed with the first to achieve the objectives of this invention. This second group can include quaternary ammonium compounds, such as monoalkyltrimethyl or triethylammonium salts such as monoalkyltrimethylammonium chloride, monoalkyldimethyl or monoalkyldimethyl-substituted benzylammonium salts, heteroaromatic ammonium salts, dialkyldimethylammonium salts, bis-quatemary ammonium salts, polysubstituted quaternary ammoniums salts and polymeric quaternary ammonium salts.

The second group can also include such inorganic peroxides such as hydrogen peroxide or persulfates, perborates, per carbonates and sodium peroxide, and organic peroxides such as peroxyacetic acid, or others such as other peroxy acids, cumene peroxide, hydroperoxides, diacyl peroxides and peroxyesters.

Sulfonic acids or sulfates can also be combined into the hoof bath and may include: dodecylbenzene sulfonic acid, sodium sulfanated oleic acid, sodium 1-octane sulfonate, sulfonated 9-ocatedceonic acid, sodium xylene sulfonate, dodecyldiphenyloxide disulfonic acid, sulfonated tall oil fatty acid, sodium naphtallene-sulfonic acid and 1-octane sulfonic acid.

Medium chain carboxylic fatty acids may also be added to the hoof bath and these may include: caproic, or hexanoic acid, heptanoic acid, caprylic or octanoic acid, nonanoic acid, capric or decanoic acid, lauric acid, myristic acid linoleic acid or linolenic acid or their esters such as methyl caprylate, methyl caprate, methyl laurate, lauryl acetate, glycerol monolaurate and amides of fatty acids, such as lauryl methylamide and dodecylamine.

The composition also might include raw elemental iodine and complexed iodinated compounds or iodophors. Carriers might include such surfactants as nonyl phenol ethoxylates, linear alcohol ehtoxylates, block co-polymers, or such polymers as polyvinylpyrridone (PVP).

The composition may also include chlorinated compounds such as chlorine dioxide or stabilized chlorine dioxide, salts of chlorine (sodium chorite) or organic chlorinated compounds (chloroisocyanurate), Phenolic compounds such as phenol and pheonlic esters of p-hydrobenzoic acid (methylparaben, propylparaben) may also be included in the second group of the composition.

All of the components in each group could be used in any combination and number of ingredients as long as there are at least two (at least one from each group) are being used at any one time. Each of these components can be used in any quantity or concentration as long as the concentration does not interfere or prevent another of these components from being added so that at least two compounds are able to be mixed at the site of use.

In addition to these components, there could be pre-added or added at the site at any concentration such components as acids including either organic acids such as acid, citric acid, acetic acid, inorganic acids such as phosphoric acid, sulfuric acid, nitric acid, surfactants, stabilizers, chelating agents, emulsifiers, thickeners, dyes and fragrances.

One advantage of combining two or more of the aforementioned antimicrobial hoof bath ingredients may be an increase in the ability to kill or inhibit disease-causing microorganisms. The killing action may be synergistic or merely additive, but in any case, will be better than using more of just component alone. These advantages, as conceived on a dairy operation, may be an increased killing rate, greater resistance to the effects of organic load, less toxicity from the chemicals and lower costs. If the action is synergistic, the most important advantage is that the combined mixture will chemically have an increased bactericidal efficacy against the disease pathogen than the sum of the parts would alone. If additive, the previously mentioned advantages by combining, for example, a more toxic but lower cost chemical with a less toxic one that costs more. In this case, toxicity will be avoided by combining the two instead of using more of the toxic chemical alone and some costs savings will be achieved by using the mixture instead of using just more of costlier component.

Some manufacturers have combined various types of anti-foot disease chemicals or biologics and sold them as a ready-to-use pre-mixed product. This approach entails certain advantages such as a lack of stability that occurs when certain chemicals or biologics are combined. The previously mentioned combination of an inorganic salt combined with peroxide is a good example. The peroxide component will then oxidize quickly and after a relatively short period of time be rendered ineffective. Additional problems of storage or transport may occur if the combined constituents produce a mixture that may be volatile causing the release of gas at higher temperatures, which may therefore increase the risk of leaking or explosion if the containers are not properly vented.

### BRIEF DESCRIPTION OF THE DRAWINGS

FIG. 1 is a schematic view of a hoof bath system in accordance with the present invention;

FIG. 2 is a schematic plan view of a hoof bath system in accordance with the present invention;

FIG. 3 is a schematic plan view of a hoof bath system in accordance with the present invention having a pair of baths in a series arrangement;

FIG. 4 is a schematic plan view of a hoof bath system in accordance with the present invention having a pair of baths in a parallel arrangement;

FIG. 5 is a schematic plan view of a hoof bath system having two lanes of baths in series;

FIG. 6 is a schematic plan view of a hoof bath system having two lanes of baths in series and having a chemical powder mixer/dispenser;

FIG. 7 is an elevational view of a control panel for use in a hoof bath system in accordance with the present invention;

FIG. 8 is a cover panel for the control panel of FIG. 7;

FIG. 9 is a perspective view of a hoof bath in accordance with the present invention;

FIG. 10 is a cross-sectional perspective view of a hoof bath in accordance with the present invention;

FIG. 11 is an elevational view of a pneumatic bladder in a deflated position to drain fluid from a hoof bath in accordance with the present invention;

FIG. 12 is an elevational view of the pneumatic bladder of FIG. 11 in an inflated position to retain fluid in a hoof bath;

FIG. 13 is a perspective view of an angled hoof bath upstream end;

FIG. 14 is a control panel for a hoof bath system having an operator-controlled pneumatic bladder valve;

FIG. 15 is an elevational view of chemical powder mixing canisters in accordance with the present invention;

FIG. 16 is a suitable programming sequence for use in a hoof bath system in accordance with the present invention;

FIG. 17 is a PLC cycle chart for use in a hoof bath system in accordance with the present invention;

FIG. 18 is a perspective view of a bulk feed system in accordance with the present invention;

FIG. 19 is a perspective view of an installed foot bath kit in accordance with the present invention;

FIG. 20 is a top view of a pair of footbaths arranged in series;

FIG. 21 is a top view of a pair of footbaths arranged in series;

FIG. 22 is a perspective view of a manifold of the foot bath kit depicted in FIG. 19;

FIG. 23 is an end view of the bladder assembly in accordance with the present invention;

FIG. 24 is an exploded view of a bladder assembly of the foot bath kit depicted in FIG. 19;

FIG. 25A is a rear perspective view of a bridge support for use in the bladder assembly in accordance with the present invention;

FIG. 25B is a front perspective view of the bridge support of FIG. 25A;

FIG. 25C is a side view of the bridge support of FIG. 25A;

FIG. 26 is an end view of a footbath in accordance with the present invention having heat tubes embedded in the floor.

FIG. 27 is a cross-sectional view taken along line 24-24 in FIG. 22; and

FIG. 28 is a cross-sectional view of an inflated bladder in accordance with the present invention.

### DETAILED DESCRIPTION OF THE PREFERRED EMBODIMENTS

In the following detailed description of the preferred embodiments, the same reference numeral will be used to identify the same or similar feature in each of the figures. In some portions of the description, the term “hoof” is used, and in others the term “foot” is used. The terms are used interchangeably and are not intended to define a distinguishing or limiting characteristic of the invention.

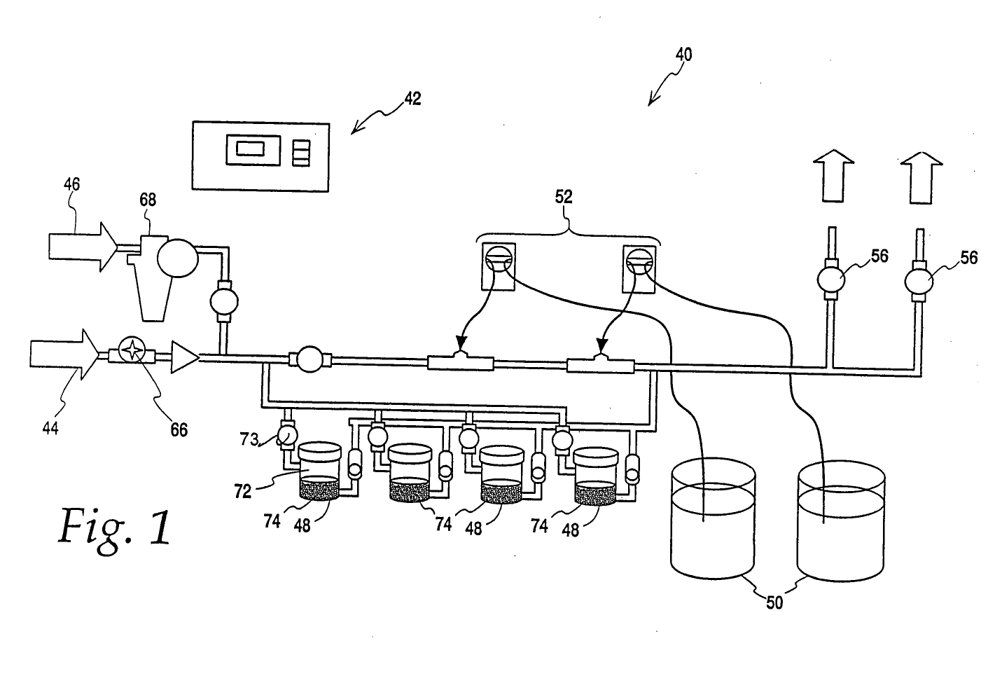

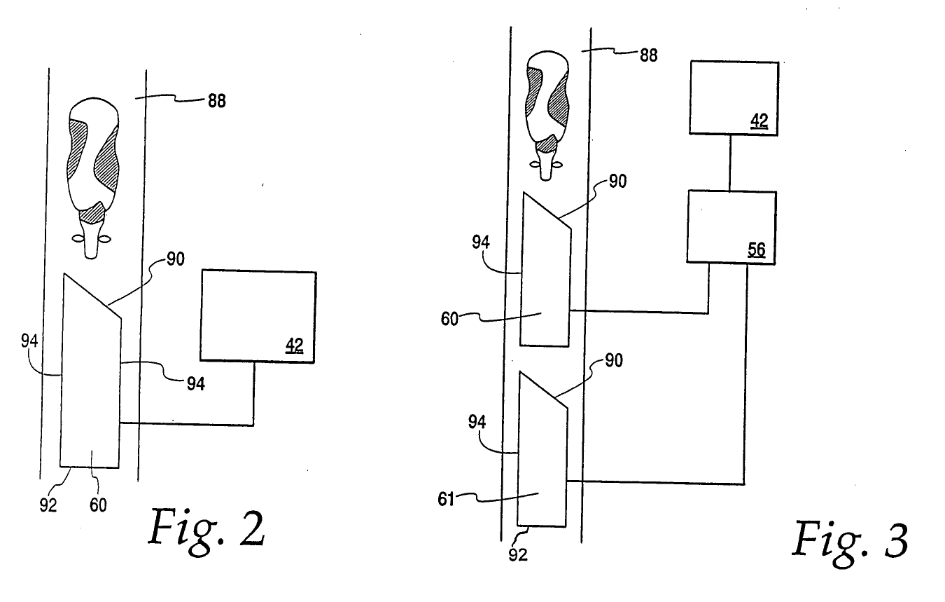

FIG. 1 is a schematic view of a hoof bath system 40 in accordance with the present invention, including a controller 42, a water supply 44, an air supply 46, a powder chemical dispenser 48, a liquid chemical dispenser 50, a pumping station 52, a water and chemical distribution network 54, and a control valve system 56. These components feed at least one hoof bath 60 as illustrated in FIG. 2. Also used in the system 40 is a drain 62.

The hoof bath system 40 provides a useful automated or semi-automated system for controlling hoof diseases in dairy animals by directing animals through at least one hoof bath 60 in which water and/or hoof treatment chemicals are disposed. The animal's hooves are thereby cleaned of a substantial amount of soil, such as dirt and manure. The chemicals can provide prevention or treatment of diseases that affect hooves.

The controller 42 can be any kind of programmable or manual controller of valves, pumps, drains and dispensers. Preferably, the controller 42 is programmable and fully automated to relieve a dairy operator from devoting valuable time and energy to hoof bath operation. The controller 42 can be any type of computer or printed circuit board. It can have the ability to receive various controlling operations and to receive data regarding hoof health for the dairy animals so that chemical type and quantity are automatically dispensed to address specific herd health needs.

In addition, flushing and re-filling frequency can be manually or automatically adjusted based on these factors. Finally, even when automation is not lo desired or feasible, the controller 42 can notify a dairy operator of conditions, flushing or re-filling operations, etc. so that the system 40 need not be monitored consistently.

The water supply 44 can be any standard water supply system for a dairy and need not supply potable water. Similarly, the air supply 46 is standard, but could be used to provide special gases necessary for mixing with chemicals. Suitable water filters 66 and air filters 68 are desirable.

In the present invention, both powder and liquid forms of chemicals can be used. It is desirable to use powder chemicals for reduced expense and increased shelf-life, but conditions and chemical types may control which type or combinations of chemicals are appropriate under given circumstances.

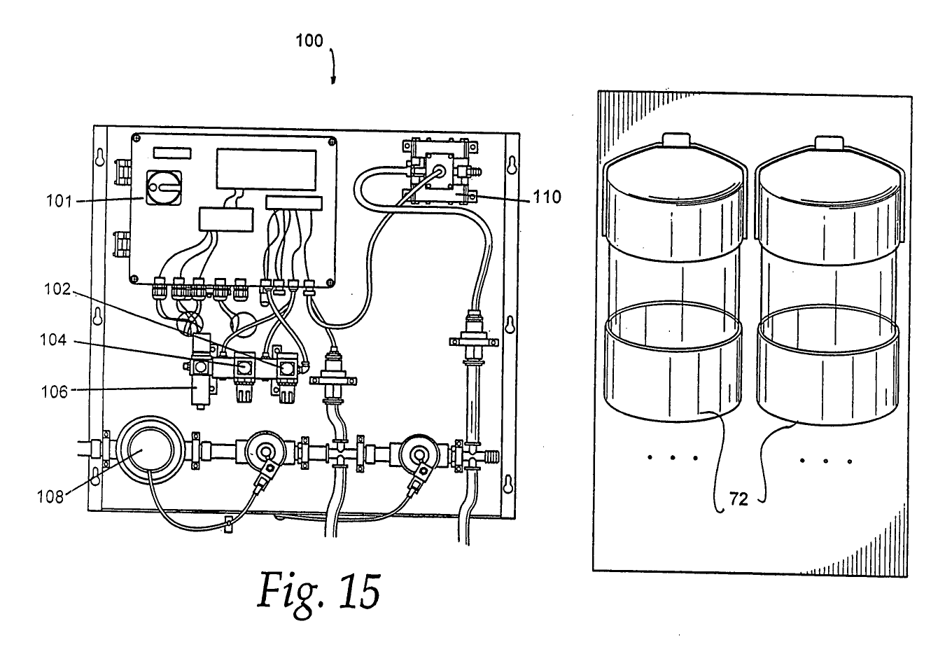

In the illustrated embodiment, powder chemical dispensers 48 are arranged in a pipe and valve network 70. Four canisters 72 are illustrated in FIG. 1 (and two are illustrated in FIG. 15), but one or more canisters could be used. Preferably, each individual canister 72 is partially filled with powdered chemicals 74 and then filled with a liquid mixing agent such as water or other liquid chemical. Each canister 72 is then filled with enough mixed chemical to supply an individual hoof bath. In this example, the appropriate amount of chemical is provided without complexing, mixing or metering from a bulk container.

Each canister—preferably is sized to receive enough powdered chemical to treat 150 to 200 cows depending upon soil load, chemical strength, and other factors. There can be multiple canisters to receive extra powdered chemical volume or a variety of chemicals. One canister is used each time a bath 60 is filled.

Once each canister is filled with powdered chemical it is filled with an appropriate amount of water to form a liquid solution. This solution can be concentrated to mix with more water prior to being added to the bath or in the bath itself, or the solution can be diluted to the proper amount in the canister.

The canisters are provided with fill valves 73 for the water or other liquid that will be mixed with the powdered chemical. The liquid may itself be a liquid chemical solution so that the combination of liquid chemical and powdered chemical provides an efficacious mixture of chemicals that need not have a long shelf-life prior to use in the bath. In this manner, varying chemical doses, mixtures and types is easily performed to obtain a highly effective hoof bath treatment chemical in an efficient and automated system 40.

Each canister also preferably includes a proximity sensor (not illustrated) that identifies the presence of powdered chemical or whether the canister is even closed properly. If neither of these conditions is met the canister will not fill with liquid, which could cause a spill.

Instead of, or in addition to the canister, the system may include mechanisms for injecting ozone (O₃) into the bath to disinfect the bath 60 and various pipes, nozzles, etc. in the chemical and/or water distribution system. No sanitizing chemicals may be necessary if this approach were used.

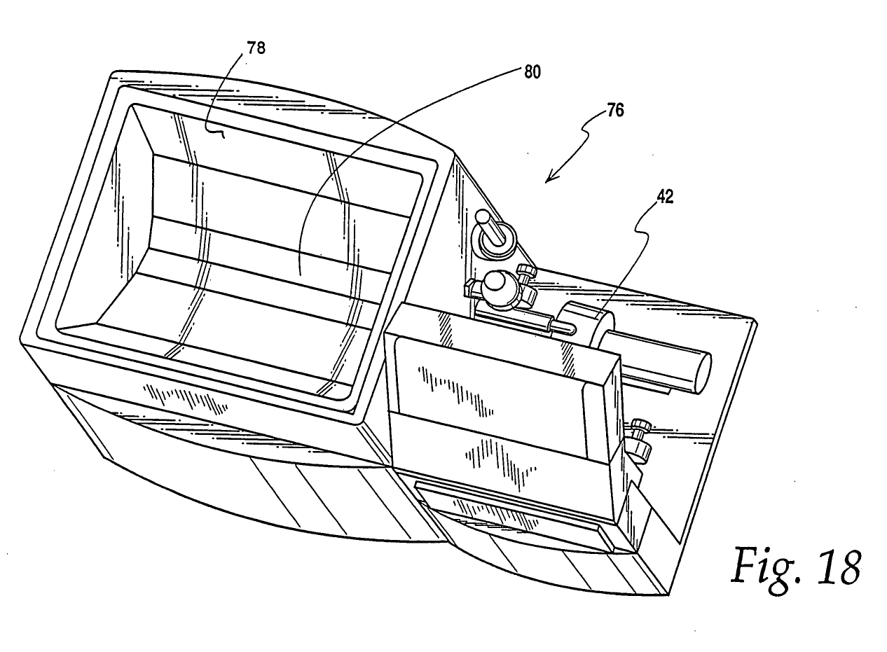

The individual canisters 72 can be filled by an operator or automatically by a bulk feed system 76. (FIG. 18.) The bulk feed system 76 includes a hopper 78 for receiving large loads of powdered chemical. An auger 80 in the hopper bottom moves chemical to a distribution shoot and then to individual canisters 72. When large containers (not illustrated) are used to mix powdered chemicals prior to use in the hoof baths, the bulk feed system 76 can be used to provide any desired amount of powder to the mixing container. Alternately, an adductor could be used to siphon chemical powder from a storage bin or hopper 78, which uses a venturi induced vacuum to carry chemical powder to a mixing canister or directly to a pipe in which the chemicals are mixed into solution.

The liquid chemical dispensers 50 can be used to store powdered chemicals after they have been mixed with water or to store liquid chemicals purchased in that form. They can be pumped into the water and chemical distribution system 54 as needed or in total, depending upon their capacity.

The chemicals in liquid form are pumped to the hoof baths 60 via the pumping station 60 through the water and chemical distribution network 54. The controller 42 can be used in conjunction with the pumping station 52 to pump only water from the water supply 44, only chemicals, or a mixture of the two, based on the operation stage of the hoof bath 60.

In addition, the controller 42 (FIG. 1) can be used to alternately operate the control valve system 56 to feed water, chemicals, and mixtures thereof to select hoof baths 60 when more than one are present.

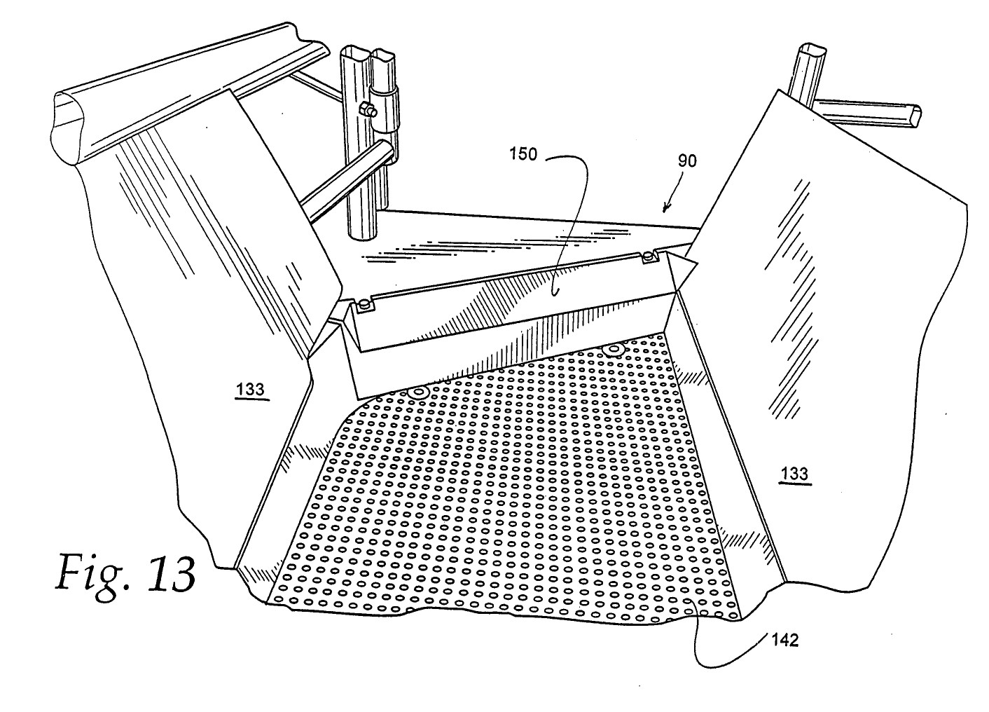

In the present hoof bath system 40, any type or size of hoof bath can be used, and in particular a number of any such hoof baths can benefit from the system of the present invention. Nonetheless, a preferred hoof bath 60 is illustrated in FIGS. 2 through 6 and FIGS. 9 through 13.

As depicted, each hoof bath 60 is disposed in a walkway that controls animal movement and requires each animal to walk through the bath 60. Despite being forced to walk through the bath 60, its configuration in accordance with the present invention is preferably raised above the walkway for ease of installation and maintenance. Ramps or platforms (not illustrated) are provided for the animals.

Each bath 60 is generally longer than it is wide and has an upstream end 90, a downstream end 92, and sides 94. The upstream end 90 is disposed at an angle, approximately 45° in the illustrated embodiments, to the walkway so that the animals can step into the bath 60 without breaking stride. This arrangement is important to dairy efficiency because it keeps animals moving with minimal congestion and it keeps the animals comfortable. This arrangement also includes a downstream end that is disposed at an angle for efficient animal movement through the bath 60. The upstream end 90 and the downstream end 92 can be parallel to one another or at any angle relative to the sides to accommodate animal movement.

Each lane is preferably sloped downward so that water and other liquids and soils flow in the same direction as cow traffic. The angled upstream end 90 of the bath therefore redirects the flow to the side so that it does not flow into the bath 60. In addition, a lip extending upstream away from the upstream end 90 of the bath 60 prevents higher velocity lane drainage from flowing into the bath.

In addition, the bath 60 is preferably dimensioned so that each animal hoof takes at least two steps in the bath 60 such that a preferred bath length is 108″. Such a dimension improves overall bath performance by ensuring adequate rinsing and chemical treatment of each animal hoof. The bath 60 may also include gradations in the side walls to indicate the volume or depth of fluid in the bath 60 for operator inspection.

The bath 60 can be made of any suitable material, including metal, plastic, and concrete, for example. The bath 60 can be pre-cast or cast-in-place. The bath 60 can be manufactured by a dairyman or any third party and fitted with the chemical and water supplies described herein, as well as drainage systems, air bladder gates and so on.

With typical soil loads, a hoof bath 60 in accordance with the present invention will require flushing every 150 to 200 animals being treated. A dairy operator can monitor this number and flush the hoof bath 60 or the flush can be automated.

When automated, the flushing operation can be initiated in several ways. One option is to automatically count cows as they pass through the bath 60 with either a proximity sensor or a wand switch (not illustrated) mounted in the lane. Counting cows automatically is a reliable way to ensure cleanliness of the bath 60 and efficacy of bath chemicals.

Another option is to initiate flushing in conjunction with the milking operation because the hoof bath 60 will typically be placed near a milking parlor exit. The bath 60 can be flushed and refilled at the start of milking by using one or more cow sensors in the milking parlor, for example. Another option is to initiate flushing at a predetermined time after the end of milking as sensed by the milker units. Refilling the bath 60 can then take place when the sensor senses the milker unit back in operation. In that way, the bath 60 will be filled shortly before the cow arrives.

Another option flushes and refills each bath 60 when the sensor signals an end to the milking cycle, provides a lag time for the last cow to move out of the parlor and through the bath 60, and then flushes and refills the bath in time for the next milking operation. Obviously, the number of cows, the frequency of milking, the shelf-life of treatment chemicals, bath soil loads, and other environmental conditions will be factors in determining when and how often the bath 60 needs to be flushed and refilled. The automated controller 42 is preferably programmable by the dairy operator to accommodate each particular dairy's varying needs.

In FIG. 3, there is an upstream bath 60 and downstream bath 61 in series, which requires each animal to walk through both baths 60. In this arrangement, an upstream bath 60 can be used to rinse and clean the animal hooves, while the downstream bath 61 is used to treat the hooves. In such an arrangement, the upstream bath 60 may be water alone or include chemicals useful in cleaning hooves. In the downstream bath 61, medicines or other chemical treatments can be used.

The two baths 60, 61 are preferably fed from the same water and chemical distribution network 54 with the control valve system 56 and controller 42 working in conjunction to feed appropriate flushing, water, and treatment chemicals to each bath.

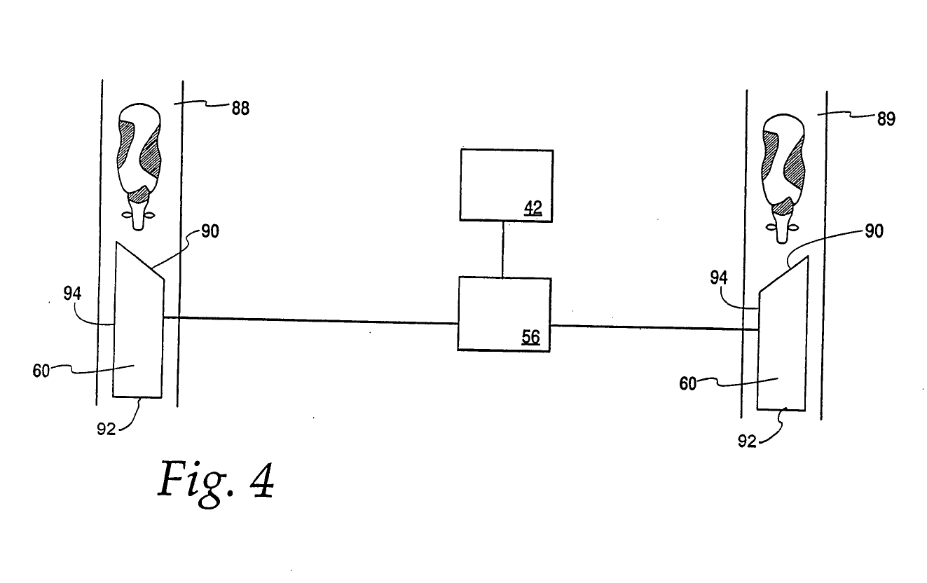

Similarly, the hoof bath system 40 may include a pair of baths 60 in a parallel arrangement, as illustrated in FIG. 4. With such an arrangement, two lanes of animal traffic can be accommodated as described above in reference to FIG. 2. In this arrangement, the controller 42 and control valve system 56 feed each bath 60 and 61. Each bath can receive the same water and chemical combinations, or each bath may receive different chemical and water solutions to treat animals in each lane differently. For example, animals with hoof diseases can be controlled through one lane for intensive treatment while other healthier animals are controlled through the other lane.

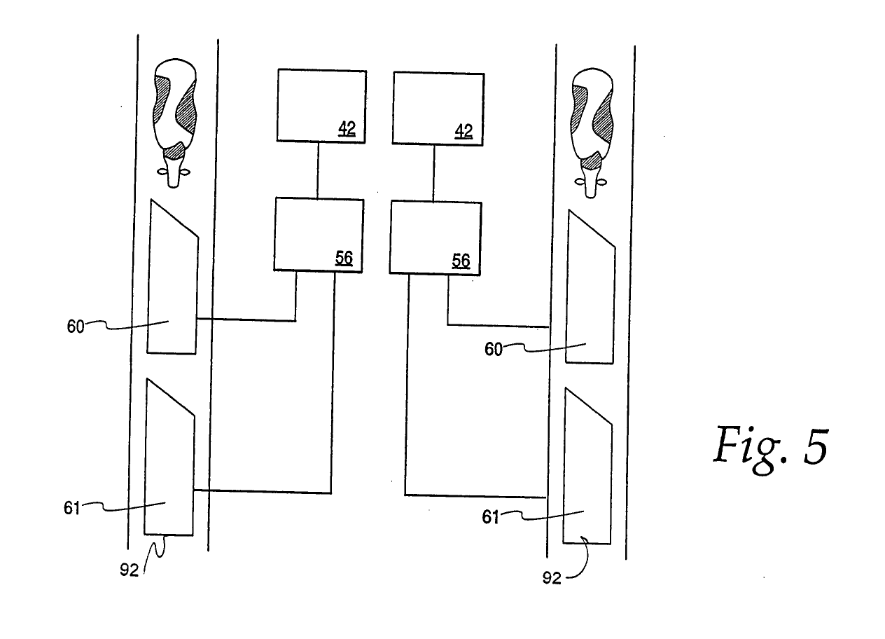

A combination of series baths from FIG. 3 and parallel baths from FIG. 4 are illustrated if FIG. 5 so that any desired form of pre-treatment and treatment can be used.

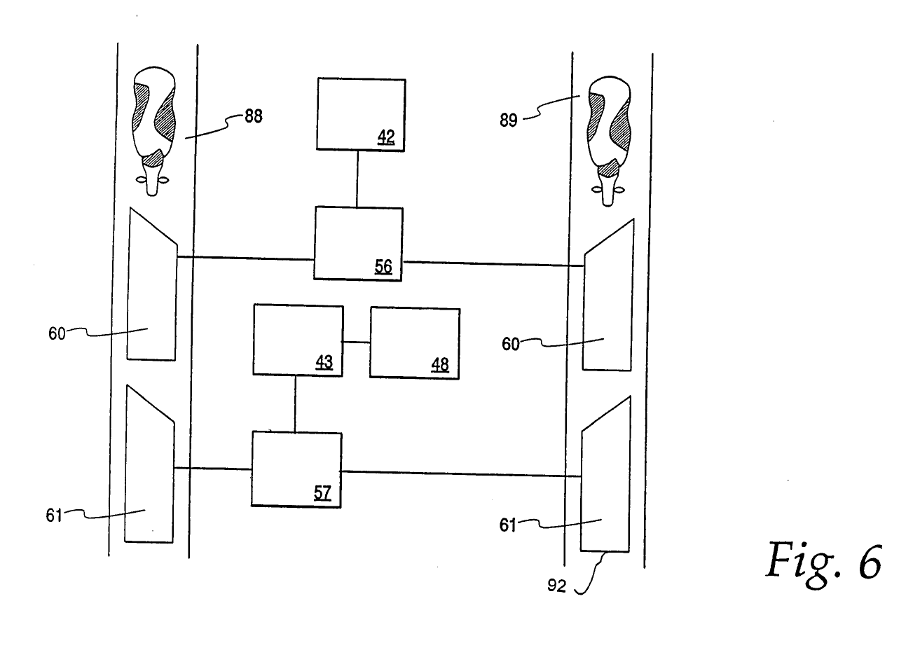

In FIG. 6, there is a system 40 similar to the system 40 in FIG. 5 except that the upstream baths 60 are fed by a first controller 42 and control valve system 56 and the downstream baths 61 are fed from a separate controller 43 and control valve system 57. The second controller 43 may be used in situations when chemicals are only fed to the downstream baths 61 and not the upstream baths 60.

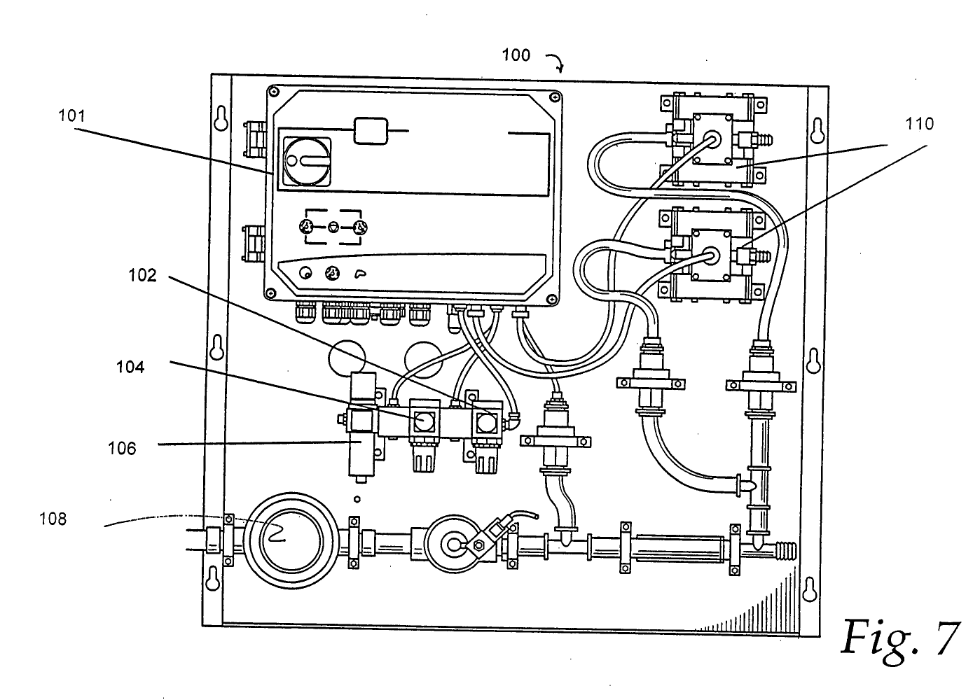

FIGS. 7 and 15 illustrate a control panel 100 that is at least part of the controller 42. The controller 42 may include computers and other control panels as well. The control panel 100 illustrated includes a PLC control, switching for purge air regulators 102, bladder air regulator 104, pump air regulator 106, a water meter 108, and liquid chemical pumps 110. With such an arrangement in the control panel 100, an operator can monitor and operate the hoof bath system 40 of the present invention at any location.

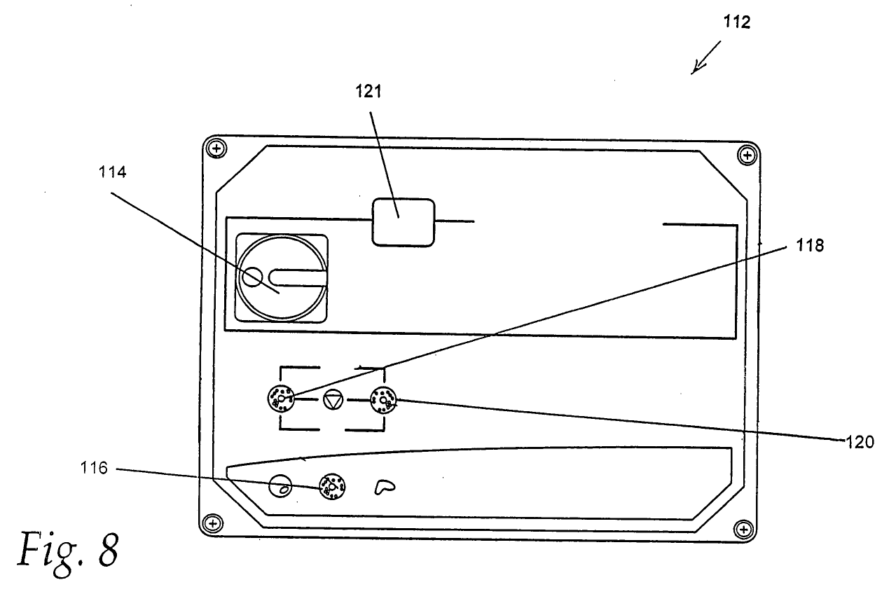

FIG. 8 simply illustrates the cover 112 for the control panel including a main power on/off switch 114, chemical and water control switches 116, automatic stop/flush switch 118 for a first bath, a similar switch 120 for a second bath, and a display 121.

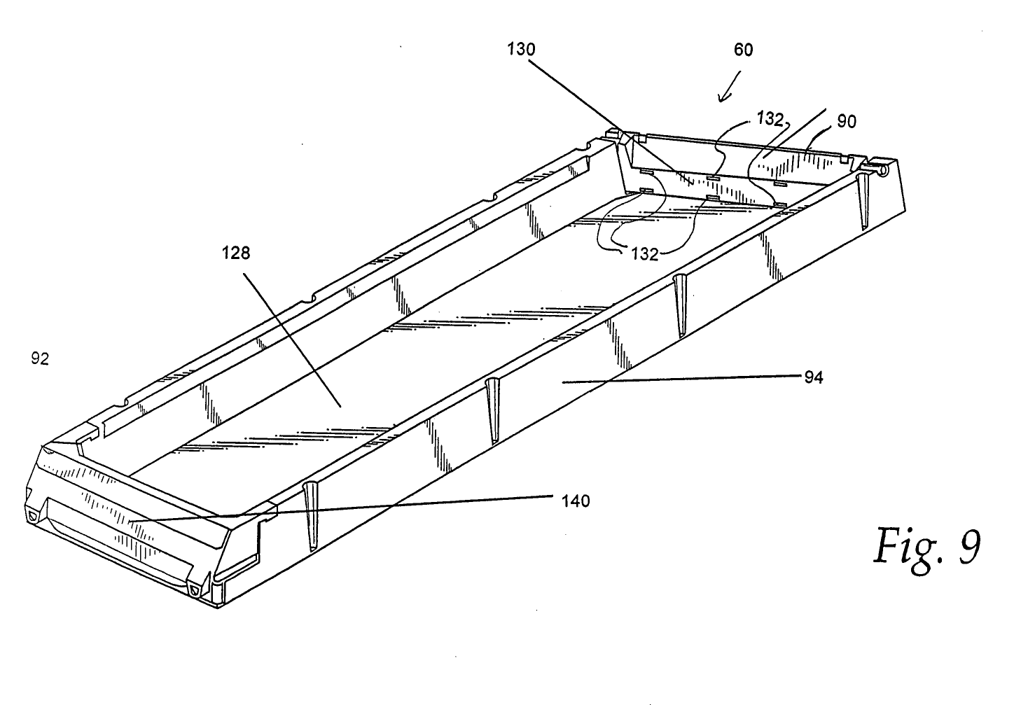

More detailed illustrations of the hoof bath 60 appear in FIGS. 9 through 13. In FIG. 9 the bath 60 includes the upstream end 90, downstream end 92, and sides 94 as generally described above.

The bath 60 is preferably made of heavy-duty cross-linked polyethylene plastic, but other materials can be used as well. In addition, a rubber mat 128 is disposed in the bottom for better footing. The mat 128 can be replaced with other similar mats or mats of differing properties as weather and bath soil conditions vary.

The upstream end 90 includes a liquid distribution manifold 130 that injects water and chemicals into the bath 60. Disposing the manifold 130 in this location is desirable because animals are less likely to kick and damage the manifold 130.

The manifold 130 includes orifices 132 through which liquid flows. (FIG. 9). At alternating times, there may be water only, chemical only, or mixtures thereof flowing out of the manifold orifices 132. The orifices are arranged downstream toward the downstream end 92 of the bath 60 despite the fact that they are disposed in the angled upstream end 90 of the bath 60. Side baffles 133 extending inwardly from the sidewalls 94 can be used to reduce some splashing from the manifold 130 injections.

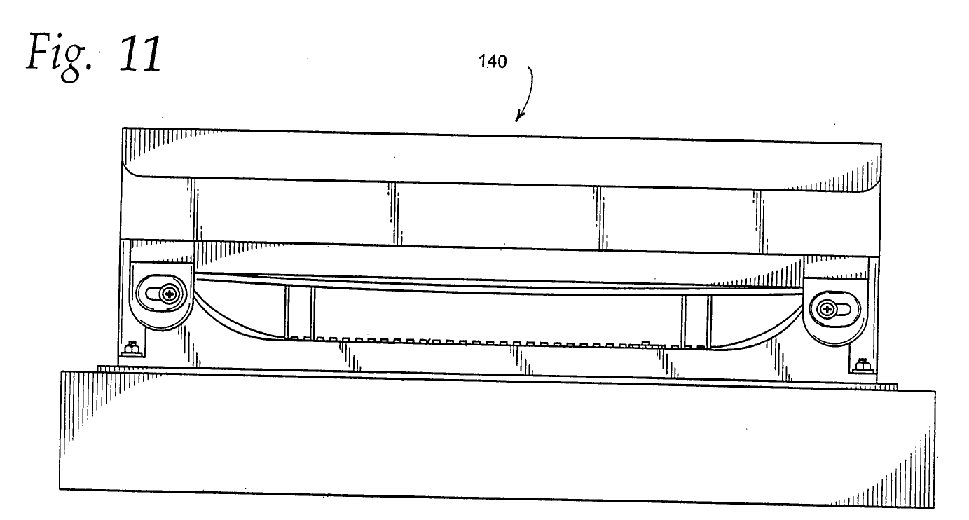

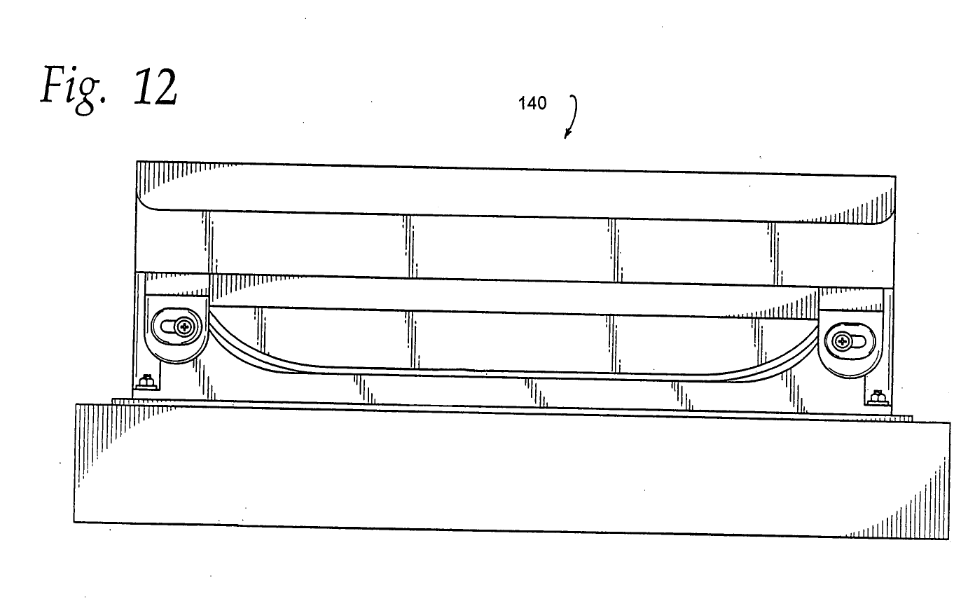

In the preferred embodiment, the downstream end 92 of the bath 60 includes a pneumatic bladder “gate” 140 that is inflated to close off the downstream end 92 (FIG. 12) and thereby retain fluid in the bath 60. The bladder 140 is deflated to release fluid and debris from the bath 60 (FIG. 11). The pneumatic bladder 140 provides a superior seal against leakage as compared to moving plates and is less likely to clog than a drain or valve arrangement.

By simply deflating the bladder 140 (FIG. 11), liquid in the bath 60 can drain or be flushed by water from the liquid distribution manifold 130. The bladder 140 is less likely to be damaged by animals. Further, when the bladder 140 is re-inflated after flushing (FIG. 12), it can conform to the shape of obstacles or debris that was not completely flushed from the bath 60. This is not necessarily possible with a moving plate, drain, or valve that could be used in place of the bladder 140.

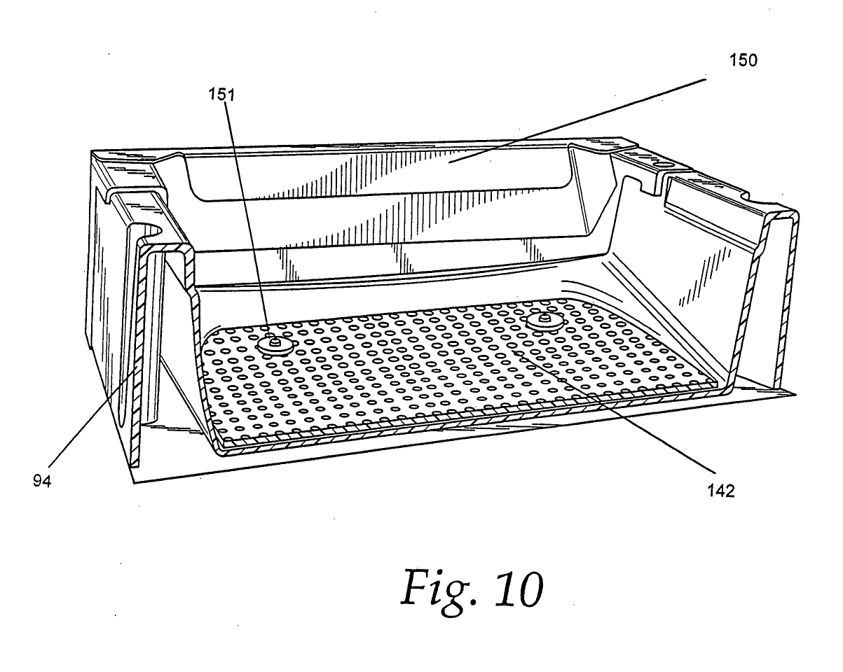

FIG. 10 illustrates further details of the hoof bath 60, including a stainless steel protective cover 150 for protecting the manifold 130. If desired, the mat 142 can be secured to the bath 60 using stainless steel fittings 151.

FIG. 11 and 12 illustrate the bladder 140 in the opened and closed positions, respectively. The bladder 140 in the opened position opens up nearly the entire width of the bath downstream end 92 to improve drainage and complete flushing of soil and debris from the bath 60.

In the inflated position, a mere nine pounds per square inch (9 psi) is adequate to seal the downstream end 92 of the bath 60.

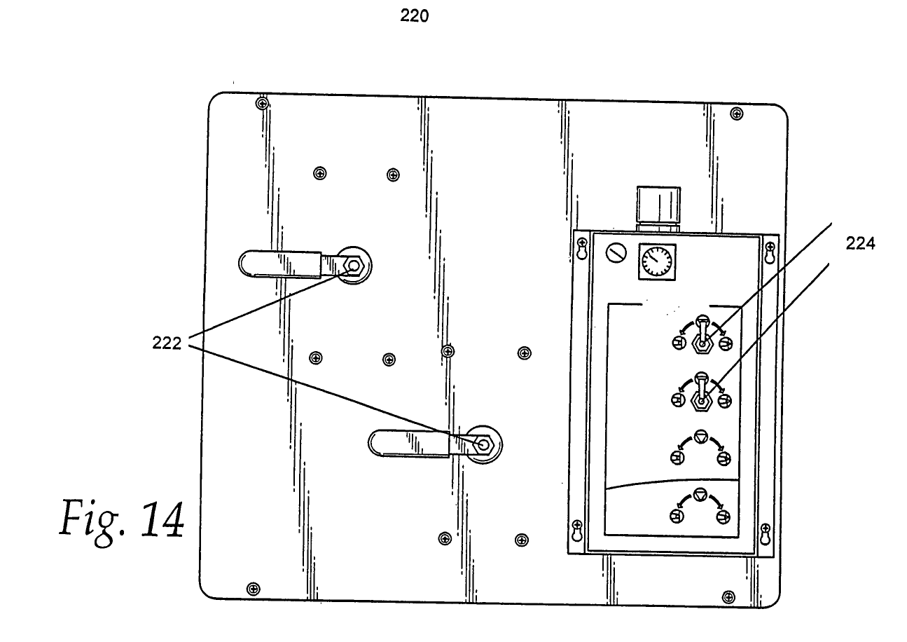

The bladder 140 can be operated with manual switches and pumps or it can be operated automatically by the controller 42. FIG. 14 is a control panel 220 having manual fill valves 222 and manual bladder open and close switches.

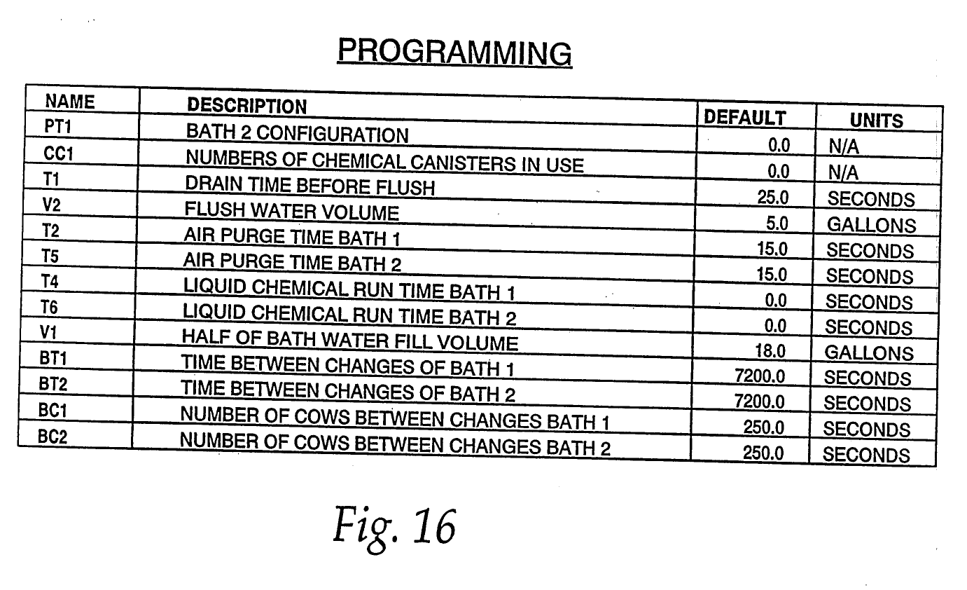

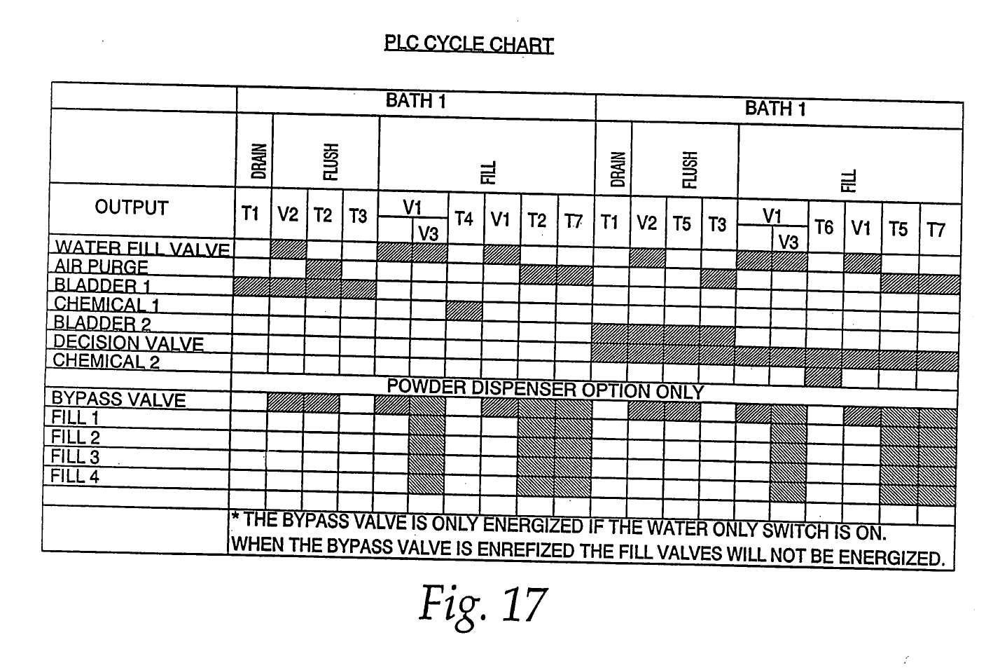

FIG. 16 illustrates a suitable programming schedule 200 and FIG. 17 illustrates a suitable cycle chart 210 for use in a hoof bath system 40 in accordance with the present invention.

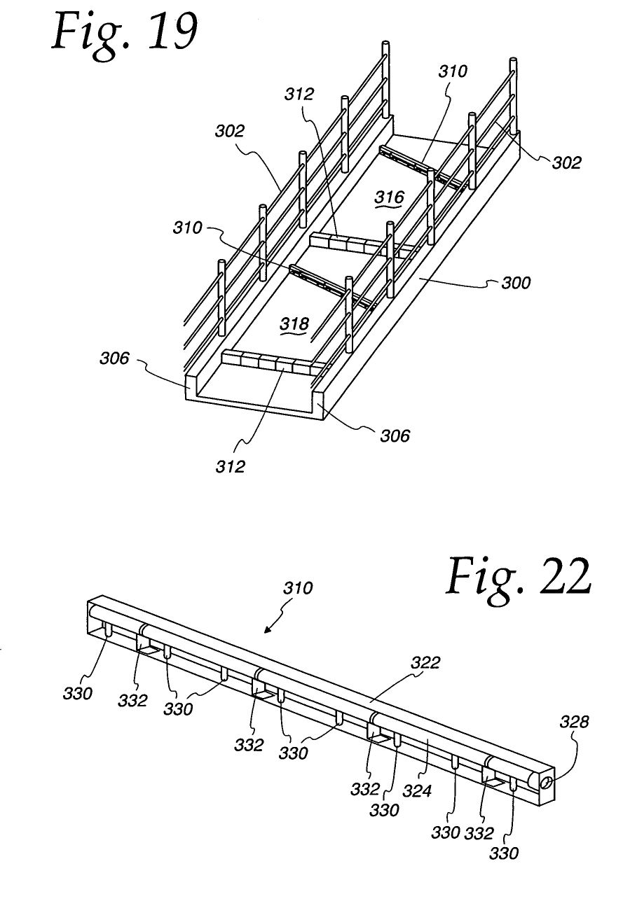

Illustrated in FIGS. 19 through 28 is another embodiment of a foot bath system in accordance with the present invention. In this embodiment, the foot bath 300 is preferably cast-in-place or pre-cast concrete. It could be made of other materials as well, but this aspect of the invention presumes that the foot bath 300 will be provided or otherwise constructed separately from the mechanical and electrical components of the system. This aspect of the invention enables the use of more permanent and robust materials for the foot bath 300 while incorporating the other preferred components of the invention and facilitating relatively simple and inexpensive repairs.

Preferably, the foot bath 300 has a floor 301 that slopes at about 1% to about 3% from the upstream end 310 to the downstream end 313. If there is a deck adjacent (not depicted), the foot bath 300 preferably includes side curbs 302 that extend upward above the floor 301 level to keep manure and deck flush water from draining into the foot bath 300. Preferably, the side curbs 302 are eighteen inches or higher from the floor 301 of the bath 300 to encourage cows to stay in the bath 300, and to reduce splashing of foot bath solution out of the bath 300.

The bath 300 is preferably substantially water impermeable to a depth of at least four inches above the floor 301 level to retain water and bath solution with minimal seepage. The bath floor 301 is also preferably level from side-to-side within about a one inch tolerance and is relatively flat and smooth (without dips) along its length for adequate and nearly complete drainage. In addition, the concrete floor directly beneath the outlet (described in detail below) 312 is preferably troweled smooth for proper and reliable closure of the drain assembly.

The bath 300 is preferably at least eight feet in length, and more preferably ten feet in length, to ensure that each cow must step in the bath 300 with all four feet and to ensure that each cow's rear feet are treated equally as well as its front feet. Also, preferably the entry 310 of the bath 300 is disposed at an angle of between about fifteen degrees and about thirty degrees so that the cows do not have to break stride as they step into the bath 300. This entry 310 arrangement also redirects water and debris from the deck around the bath 300 and not into it. Also, preferably the bath floor 301 is coated with an epoxy and sand combination or other suitable material to be skid resistant.

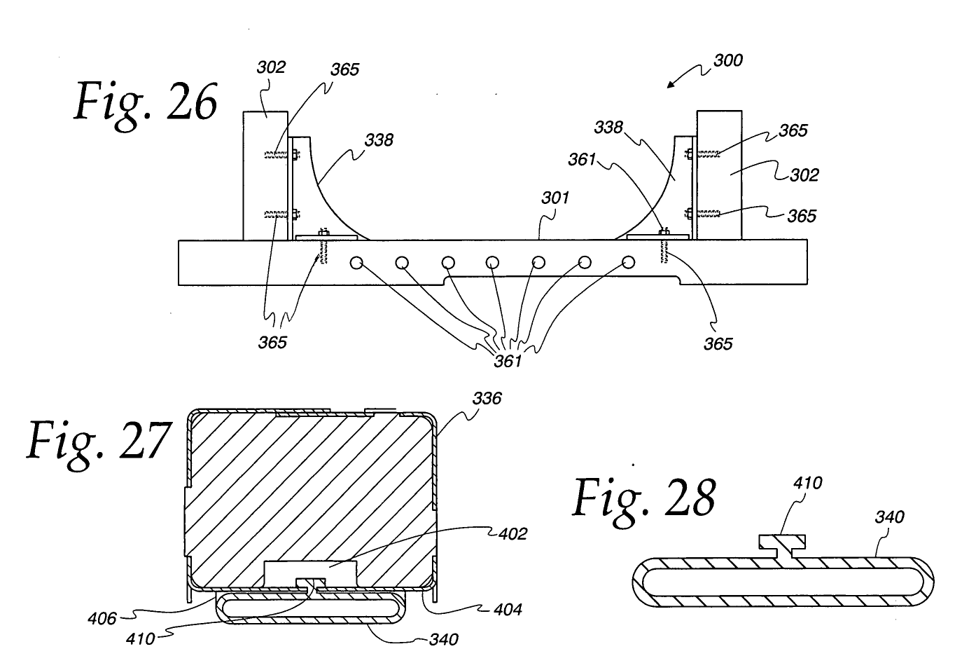

Heat elements 361 (FIG. 26) can also be cast into the bath floor 301 to prevent the bath fluids from freezing in winter. The heat elements 361 can be electric wires or tubes containing heated fluids such as air, water, or suitable antifreeze liquids or the heat elements 361 can be any other suitable heat exchanger. The heat elements 361 should be positioned to avoid being damaged by connectors 365 of other bath components during installation.

Illustrated in FIG. 19 is a foot bath 300 with side curbs 302 for guiding cows through the bath 300. Additional rails 351 can be provided to prevent cows from exiting sideways out of the bath 300. The bath 300 is relatively inexpensive to build because only a floor and bath side walls 306 and no concrete end walls are necessary. Instead, a modular inlet 310, such as a manifold, and an outlet such as a bladder assembly 312 are positioned in the bath 300 to feed, contain, and flush water, chemicals and debris.

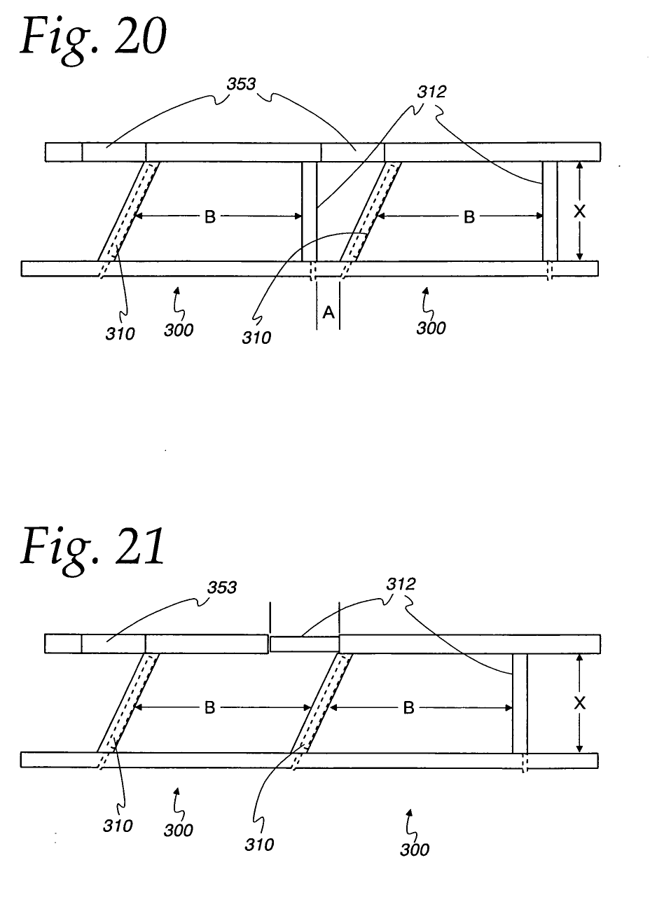

In FIG. 19, there are two baths, with each having an inlet 310 and a bladder assembly 312, to define an upstream pre-treatment bath 316 and a downstream treatment bath 318. The inlets 310 and bladder assemblies 312 could be oriented at any angle relative to the bath 300. FIGS. 20 and 21 illustrate side drains 353 to ensure that drainage of water and debris from the lanes does not contaminate the baths 300. In such an embodiment, the baths can be sloped toward the side drains 353 for more efficient drainage.

A single automated control system can be used to control a number of baths 316 and 318. Valves (not illustrated) can be used to cause one bath or the other to be fed chemicals and/or water. Preferably, these valves are pinch valves, such as model no. AP6795 available from Richway Industries, Janesville, Iowa (www.richwayind.com).

The inlet 310 is isolated in FIG. 22 and is preferably a manifold constructed of corrosion-resistant metal or plastic. In the illustrated embodiment, a frame 322 supports a conduit 324 through which water, chemicals, and liquid mixtures thereof flow. Instead of a manifold, a single pipe or a series of pipes could be used as an inlet 310. The conduit 324 preferably opens at a female fitting 328 for receiving the liquids and nozzles 330 for feeding liquids into the bath 300. The nozzles 330, preferably include one-way valves such as a rubber duck-billed valve part no. 6192 AP available from Richway Industries, Janesville, Iowa (www.richwayind.com) to reduce clogging and backflow. The duck-billed valve is preferably mounted on a one-quarter inch stainless steel nipple. Supports 332 reinforce the frame 322 and the conduit 324. The inlet 310 can be bolted or otherwise secured to the bath 300 in the desired positions and fitted to supply lines of water and chemicals in any suitable manner. The ends of the inlet 310 could be miter-cut to fit at any desired angle relative to the bath 300. It could also be cast-in-place with the concrete, but it is preferred that it be easily removable for maintenance, repair, and replacement.

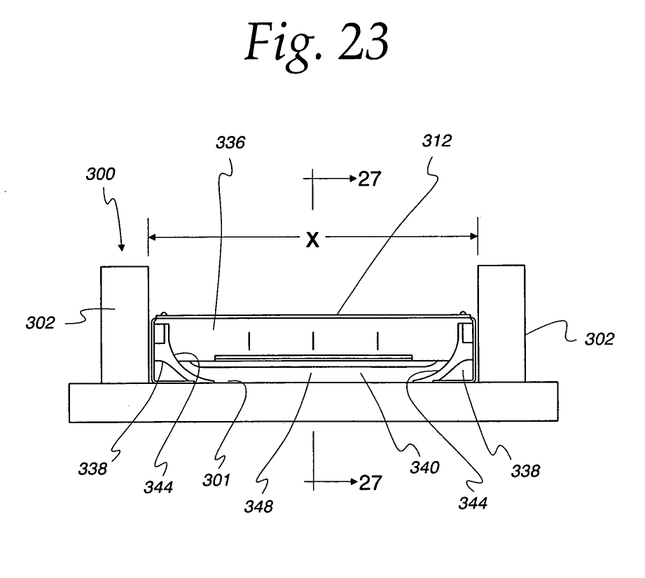

FIGS. 23 through 28 depict the bladder assembly 312 outlet or portions thereof in accordance with the present invention. In particular, FIG. 23 illustrates a bladder assembly 312 disposed in a foot bath 300 between side walls 302. The bladder assembly 312 includes a bridge 336, bridge supports 338, and a bladder 340. The bridge 336 spans the width of the bath 300 as it protects operative components from being damaged.

As seen in FIG. 23, the space beneath the bridge 336 defines a drain 348 through which water, chemicals, and debris can flow when the bladder 340 is at least partially deflated. The drain is closed by inflating the bladder 340. Other drain closures could be used in accordance with the kit of the present invention. Generically, various types of drain closures are referred to in the appended claims as “drain assemblies.”

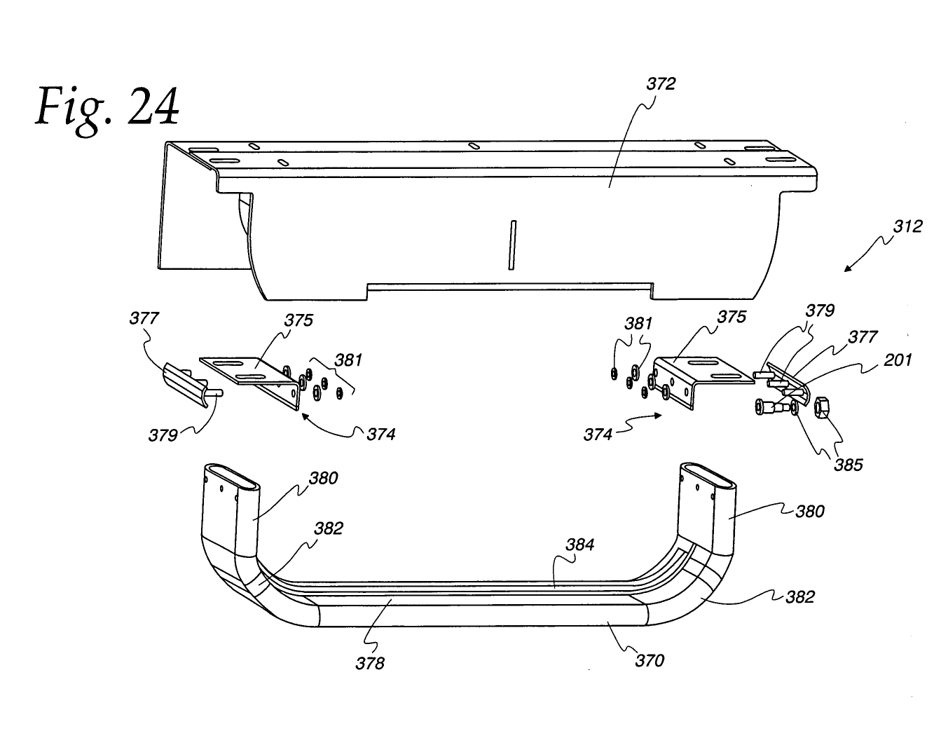

FIG. 24 is an exploded view of the bladder assembly 312 including a flexible bladder 340, an upper bridge 372, and assembly brackets 374. A T-shaped flange 410 or “T-bar” fastens the bladder 340 to the bottom of the bridge 372, as described in more detail below.

The upper bridge 372 supports the bladder 340 and is robust enough to withstand the bath environment and repeated contact by the cows. The bridge 372 preferably includes internal baffles for reinforcing the bridge 372. The bladder 340 is essentially a tube opened on each end 373 (FIG. 24), but the ends 373 are sealed using the assembly brackets 374. The brackets 374 preferably each include an L-shaped plate 375 and a clamp bar 377. Prongs 379 on the clamp bar 377 extend through mating holes in the L-shaped bracket and in the ends 373 of the bladder 340, and are secured with washers and nuts 381 to seal the ends 373 of the bladder 340.

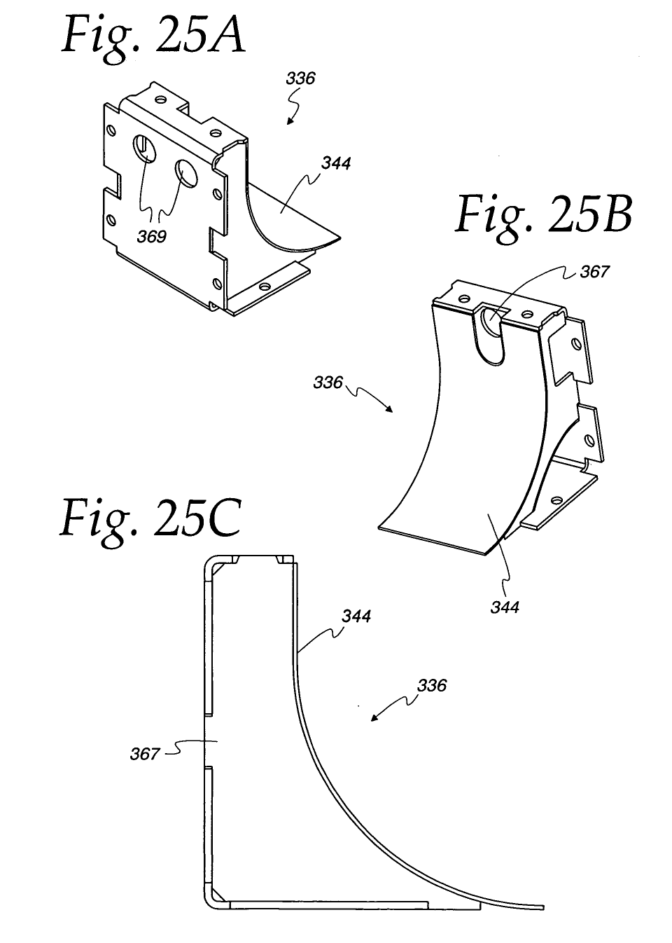

The assembly brackets 374 also affix the bladder 340 between the bridge 372 and bridge supports 344 (FIG. 25A). Suitable holes 369 and slots are provided in all of the components to simplify assembly. An air inlet fitting 201 is fitted through a hole in an outer wall of the bladder 340 and secured with a washer and nut 385 to be attached to an air hose and allow air into and out of the bladder 340.

As seen in FIGS. 25A, 25B, and 25C, the bridge 336 is supported at each end by the bridge supports 338, which are preferably shaped to fit the corners of the foot bath 300 and provide a rounded or curved surface 344 for mating with the bladder 340. A recess 367 is provided to accommodate the bladder air valve 201 described above.

The bladder 340 is inflatable so that when it is desired to close the drain 348, air is fed into the bladder 340 through a valve 201 and inflated to substantially close the drain 348 by contacting the bath 300 floor surface and the bridge supports 338 rounded surfaces 344. The bladder 340 conforms to the shape of the bath, the bridge components, any irregularities in the bath, and to any dirt or debris in the area.

When it is desired to open the drain 348 for flushing the bath 300, the bladder 340 is at least partially deflated and it retracts upward to clear the lower surface of the drain 348 for drainage. The bridge 336 is preferably installed to provide about two inches to about two and one-half inches of clearance beneath it for cow safety by reducing the risk of a cow's foot being caught beneath the bridge 336. The bladder 440 in the uninflated position is preferably above the floor about two to two and one-half inches and is of adequate size to fill the gap when inflated. The bridge 336 may be installed as its own kit or in a kit with an upstream inlet.

The bridge supports 338 are joined to the bath 300, curbs 302, and floor 301 with anchors 365 that can be bolts or other types of anchors that are preferably joined releasably to the mechanical components for ease of repair and replacement.

An optional hose opening 367 seen in FIGS. 25B and 25C allows the bladder air hose to exit above the fluid level.

FIGS. 27 and 28 illustrate one way to connect the bladder 340 to the bridge 336. The bridge 336 includes a recess 402 extending along its lower side 404. The recess 402 includes a slot 406 through which a T-bar 410 can slide to connect the bladder 340 to the bridge. The T-bar 410 is preferably made of the same material as the bladder 340, and formed integrally therewith or glued into place. Other materials could also be used to form the T-bar 410. Such an arrangement permits the bladder 340 to shift as it inflates and deflates.

The bladder 340 is preferably made of ethylene propylene diene monomer rubber (“EPDM”) and has a deflated dimension of 6 inches wide by ¾ inches high and has ⅛ inch thick walls. The length will vary based on the width of the bath but would normally be between 2 and 10 feet in length. An air pressure of 7 to 12 psi is preferably used to inflate the bladder 340, although other pressures can be used. The air line connection 20 connects to a pneumatic pump that is preferably controlled by an automated controller as described above. A manual controller could also be used.

Kits and components described herein in accordance with the present invention are available from WestfaliaSurge, Inc. located at 1880 Country Farm Drive, Naperville, Ill. 60563, under the brand name MegaBridge.

One purpose of the present system is directed to compositions and methods for mixing certain, specific and known antimicrobial components at the site of the hoof bath just prior to use by the cows. This invention enables a dairy farmer in the control of contagious diseases of the bovine foot while increasing cost savings and increasing safety to humans and animals. Evidence in the laboratory and in the field supports these contentions especially as it relates to bactericidal efficacy. It also lessens the problems associated with pre-mixing ingredients such as stability and safety in storage and transport.

The antimicrobial hoof bath chemicals and biologics are combined at the site of the hoof bath just prior to use. These components can be solid, liquid or both combined. They can be dispensed manually or by systems presently developed or in development that dispense the chemicals automatically into the hoof bath via pipes or hoses (for liquids) or automated hoppers (for solids). These devices can be set to dispense at pre-determined intervals based on time or number of cows and thereupon dispense a pre-set amount of chemicals along with water to achieve the desired dilution rate.

Prior to the addition of new chemical(s), the old, used solution along with contaminating manure or soil can be forced out or flushed automatically out of the hoof bath into a drain. The present invention of mixing components at site provides the greatest benefit when used with an automated system although it can also be practiced manually.

One example utilizing an automated flushing hoof bath entails adding, at specified intervals, pre-diluted copper sulfate, pre-diluted quaternary ammonium compound and pre-diluted hydrogen peroxide and water where the final concentration of each component would be 2% by volume. This would provide advantages over using only one of these compounds, even at a higher concentration or using them alternatively at different times or pre-mixing them at a considerable time prior to use (i.e.: time of manufacture).

The advantages would include cost savings by using less chemical and less labor to apply chemical to the hoof bath or utilize less storage space because lower amounts of the bulkier products can be used. Efficacy advantages would be expected with a greater reduction or lower rate of infection of the aforementioned foot/hoof diseases. Automated systems ensure that the chemicals or biologics are at the doses specified since the chance of degradation of components (such as the hydrogen peroxide) would be lessened if they are not mixed a significant time prior to use.

The present invention in its preferred embodiments described herein conserves water by using fewer than ten gallons of flushing liquid; has chemical resistant and durable high-strength plastic construction; utilizes a large drainage zone sealed by an effective bladder to seal the drainage zone; has a longer (108″) length that assures double treatment (two steps) of rear hooves; is automated to reduce operation interaction if desired; is programmable as dairy conditions change; accurately mixes treatment chemicals; optionally mixes a variety of chemicals that have higher potency but possibly short shelf-life; and has an automated flush and refill option that can be activated by an operator, cow counts, or milking equipment activation/deactivation. The result is a cost-effective and efficacious hoof treatment system.

The foregoing detailed description of the present invention is provided for clearness of understanding only. No unnecessary limitations therefore should be read into the following claims.

1. A foot bath component kit for being installed in a dairy animal foot bath, the kit comprising:
an upstream inlet;
a downstream drain assembly; and
installation hardware for installing the inlet and drain assembly in the foot bath.

2. The foot bath kit of claim 1, wherein:
the inlet is a manifold having a plurality of nozzles for emitting fluid into the foot bath.

3. The foot bath kit of claim 1, wherein the drain assembly comprises:
a bladder assembly.

4. The foot bath kit of claim 1, wherein the drain assembly comprises:
a foot bridge;
a bridge support joined to the foot bridge to define a drain under the foot bridge; and
an inflatable bladder secured to the foot bridge for moving between an inflated position for substantially closing the drain and an uninflated position for opening the drain.

5. The foot bath kit of claim 4, wherein the inflatable bladder comprises:
a pneumatic bladder operatively connected to the bladder assembly for movement between a closed position and an opened position.

6. A modular foot bath drain assembly comprising:
a bridge;
an inflatable bladder joined to the bridge;
an air nozzle joined to the bladder for communicating air in and out of the bladder; and
hardware to connect the drain assembly to a foot bath.

7. The foot bath drain of claim 6, and further comprising:
a T-shaped connector joined to the bladder; and
the bridge comprises a slot for receiving the T-shaped connector.

8. The foot bath drain of claim 6, wherein the inflatable bladder has a length that is substantially equal to the width of a foot bath in which the foot bath drain assembly will be disposed.

9. The foot bath drain assembly of claim 6, and further comprising:
a plurality of bridge supports joined to the bridge to define a drain under the bridge.

10. The foot bath drain assembly of claim 6, and further comprising:
a bridge support joined to the bridge, and defining a curved surface for mating with the bladder when inflated.
